(19) United States
(12) Patent Application Publication
(10) Pub. No.: US 2012/0079384 A1
(43) Pub. Date: Mar. 29, 2012

(54) LYRIC SYNCHING METHOD AND ELECTRONIC DEVICE UTILIZING THE SAME

(75) Inventor: PING-YANG CHUANG, Tu-Cheng (TW)

(73) Assignee: HON HAI PRECISION INDUSTRY CO., LTD., Tu-Cheng (TW)

(21) Appl. No.: 12/982,893

(22) Filed: Dec. 31, 2010

(30) Foreign Application Priority Data
Sep. 24, 2010 (TW) 99132399

(51) Int. Cl. G06F 3/048

(52) U.S. Cl. 715/716

(57) ABSTRACT

An electronic device includes a storage unit, an audio playback unit, a display unit, and a timer. The storage unit stores audio files and lyrics associated with the audio files. The audio playback unit plays the audio files. The display unit shows the lyrics and is a touch-enabled display. The method includes directing the audio playback unit to play an audio file back, implementing the timer, directing the display unit to show the lyric content, determining the lyric content displayed corresponding to the contact position and determining a time tag before the determined lyric content according to the recorded time; and updating the time tag with the determined time tag before the determined lyric content with the determined time tag when the lyric content is not displayed synchronously with the current audio file.

### BACKGROUND

1. Technical Field

The present disclosure relates to multimedia playback and, particularly, to a lyric synching method and electronic device using the method.

2. Description of Related Art

Many digital players provide readout of corresponding lyrics when playing back music files. However, such systems often experience difficulty in precise synchronization. Some specific software such as Minilyrics is able to modify time tags of lyrics, but the application must be downloaded, installed, and operated correctly, which is troublesome.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a block diagram of an electronic device in accordance with one embodiment.

FIG. 2 is a flowchart of a method for synchronizing lyric readout in accordance with an exemplary embodiment.

### DETAILED DESCRIPTION

Embodiments of the present disclosure will now be described in detail below, with reference to the accompanying drawings.

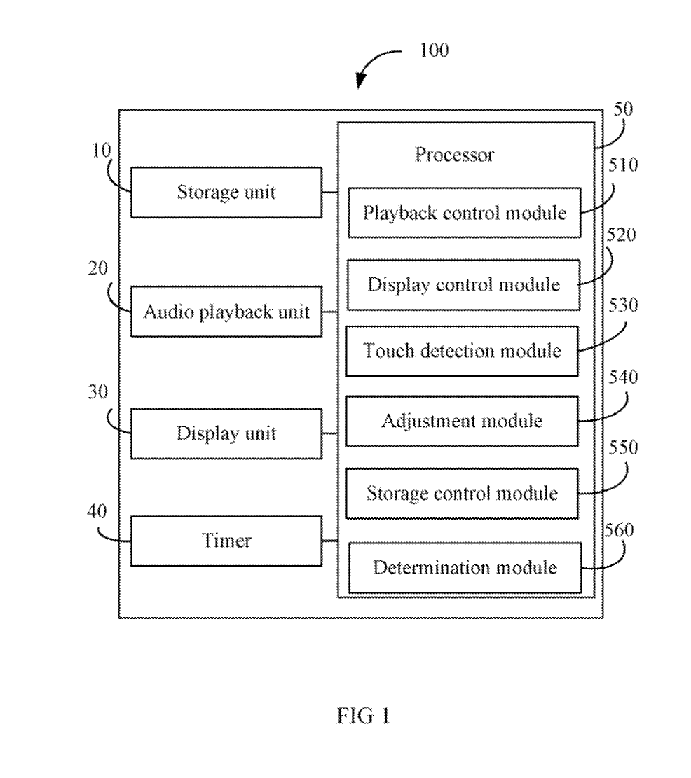

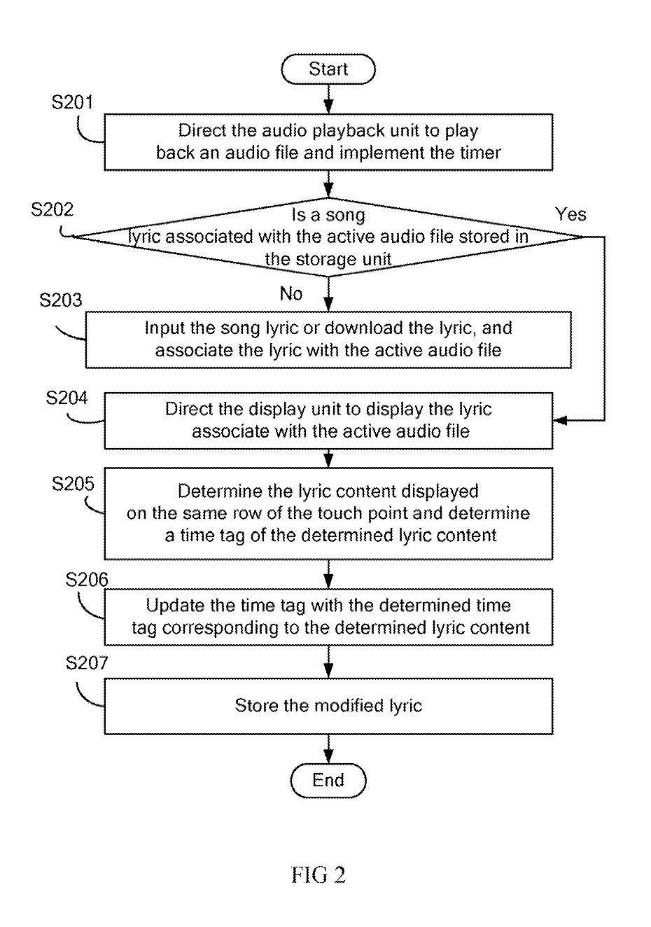

Referring to FIGS. 1-2, an electronic device 100 includes a storage unit 10, an audio playback unit 20, a display unit 30, a timer 40, and a processor 50. In the embodiment, the electronic device 100 is an MP4 player. The storage unit 10 stores audio files and corresponding lyrics files stored in the same file folder. In the embodiment, each lyric and the associated audio file have the same filename, but different extension. Here, the format of the lyrics is LRC.

The audio playback unit 20 plays back stored audio files in response to input.

The display unit 30 displays the lyric associated with the active audio file. In the embodiment, the display unit 30 is a touch-enabled display.

The processor 50 directs the audio playback unit 20 to play back an audio file in response to input, and the display unit 30 to read out the lyric associated with the active audio file. In this embodiment, when the processor 50 starts to play an audio file back, the processor 50 implements the timer 40. The processor 50 further determines whether the display unit 30 receives input during playback. If so, the processor 50 determines the lyric content corresponding to the portion of the active audio file being played displayed on the same row as the contact position, and determines a time tag of the determined lyric content according to the recorded time of the timer 40. In this embodiment, the time tag of the determined lyric content represents the time at which the lyric is displayed. The processor 50 further updates the time tag corresponding to the determined lyric content if the lyric content is not displayed synchronously with the played audio file. For example, if the lyric content does not have the time tag corresponding to the determined lyric content, the processor 50 further adds the determined time tag for the determined lyric content. If the existing time tag does not match the determined time tag, the processor 50 replaces the existing time tag with the determined time tag corresponding to the determined lyric content. The processor 50 further stores the modified lyric and resets the timer 40 after the audio file is played back.

The processor 50 further determines whether the lyric corresponding to the active audio file is stored in the storage unit 10. If no associated lyric is present, the processor 50 directs the display unit 30 to prompt for input or download of the appropriate lyric, and associates the input or downloaded lyric with the active audio file. In the embodiment, association of the lyric with the active audio file is accomplished by storage of the lyric and the active audio file in the same file folder, and naming of the lyric and the active audio file with the same filename and different extensions.

In the embodiment, the processor 50 includes a playback control module 510, a display control module 520, a touch detection module 530, an adjustment module 540, and a storage control module 550.

The playback control module 510 is configured to direct the playback unit 20 to play one audio file and implement the timer 40.

The display control module 520 is configured to direct the display unit 30 to readout the lyric associated with the active audio file.

The touch detection module 530 is configured to determine touch point on the display unit 30 during playback, determine a lyric content corresponding to the portion of the active audio file being played displayed on the same row of the touch point of the display unit (not shown), and determine a time tag corresponding to the determined lyric content according to the recorded time of the timer 40.

The adjustment module 540 is configured to determine whether the lyric is displayed synchronously with the active audio file. If the lyric is not displayed synchronously with the active audio file, the adjustment module 540 updates the time tag with the determined time tag corresponding to the determined lyric content. For example, if there is no time tag before the determined lyric content, the adjustment module 540 adds the determined time tag for the determined lyric content. If the existing time tag does not match the determined time tag, the adjustment module 540 replaces the existing time tag with the determined time tag corresponding to the determined lyric content.

The storage control module 550 is configured to store the modified lyric following playback of the audio file. In the embodiment, the storage control module 550 is further configured to reset the timer 40 following playback of the audio file.

The electronic device further includes a determination module 560. The determination module 560 is configured to determine whether the lyric corresponding to the active audio file is stored in the storage unit 10. If no associated lyric is present, the display control module 520 is further configured to direct the display unit 30 to prompt input or download of the lyric, and associates the downloaded or input lyric with the active audio file.

As configured, the electronic device 100 can modify lyric content automatically and add time tags accurately, eliminating the need for acquisition and implementation of dedicated applications therefore.

Referring to FIG. 2, a flowchart of a method for synchronizing lyric readout in accordance with an exemplary embodiment is shown.

In step S201, the playback control module 510 directs the audio playback unit 20 to play back the audio file and implements the timer in response to input.

In step S202, the determination module 560 determines whether the lyric associated with the active audio file is stored in the storage unit 10. If no, the procedure goes to step S203. If yes, the procedure goes to step S204.

In step S203, the display control module 520 directs the display unit 30 to display a user interface to prompt the user to input the lyric or download the lyric through Internet, and associates the lyric with the active audio file.

In step S204, the display control module 520 directs the display unit 30 to display the lyric associate with the active audio file lyric content by lyric content.

In step S205, the touch detection module 530 determines that a touch point on the display unit 30 during playback, further determine a lyric content corresponding to the portion of the active audio file being played displayed on the same row of the touch point of the display unit and determines the time tag of the determined lyric content.

In step S206, the adjustment module 540 updates the time tag with the determined time tag corresponding to the determined lyric content when the lyric is not displayed synchronously with the active audio file. Specifically, the adjustment module 540 adds the time tag corresponding to the determined lyric content if there is not a time tag corresponding to the determined lyric content, and replaces the existing time tag with the determined time tag corresponding to the determined lyric content if the existing time tag does not match the determined time tag corresponding to the determined lyric content.

In step S207, the storage control module 550 stores the modified lyric after playback of the audio file. The storage control module 550 further resets the timer following playback of the audio file.

While various embodiments have been described and illustrated, the disclosure is not to be constructed as being limited thereto. Various modifications can be made to the embodiments by those skilled in the art without departing from the true spirit and scope of the disclosure as defined by the appended claims.

What is claimed is:

1. An electronic device comprising:
a storage unit to store audio files and lyrics associated with the corresponding audio files;
an audio playback unit to play the audio files stored in the storage unit;
a display unit to display the lyric associated with the active audio file, the display unit being a touch-enabled display;
a timer; and
a processor to direct the audio playback unit to play the audio file and implement the timer, control the display unit to show lyric content of the lyric associated with the audio file lyric content being played, further determine a touch point on the display unit, and determine a lyric content corresponding to the portion of the active audio file being played displayed on the same row of the touch point of the display unit, and determine a time tag corresponding to the determined lyric content according to the recorded time of the timer, and further update the time tag with the determined time tag corresponding to the determined lyric content when the lyric does not match the active audio file.

2. The electronic device as described in claim 1, wherein each of the lyrics and the associated audio file has the same filename, but the different filename extension.

3. The electronic device as described in claim 1, wherein the processor further determines whether the lyric associated with the active audio file is stored in the storage unit, if the lyric associated with the played audio file is not stored in the storage unit, the processor is to direct the display unit to display a user interface to prompt to input the lyric or download the lyric through Internet, and further associate the lyric with the active audio file.

4. The electronic device as described in claim 1, wherein the processor updates the time tag with the determined time tag corresponding to the determined lyric content when the lyric is not displayed synchronously with the active audio file specifically comprises: the processor adds the determined time tag corresponding to the determined lyric content if there is not a time tag corresponding to the determined lyric content, and replaces the existing time tag with the determined time tag corresponding to the determined lyric content if the existing time tag does not match the determined time tag corresponding to the determined lyric content.

5. The electronic device as described in claim 1, wherein the processor further stores the modified lyric to the storage unit.

6. The electronic device as described in claim 1, wherein the processor is further to reset the timer when the played audio file is played back.

7. An electronic device comprising:
a storage unit to store audio files and lyrics associated with the corresponding audio files;
an audio playback unit to play the audio files stored in the storage unit;
a display unit to display the lyric associated with the active audio file, the display unit being a touch-enabled display;
a timer; and
a processor comprising:
a playback control module configured to direct the audio playback unit to play one audio file and implement the timer;
a display control module configured to direct the display unit to show the lyric associated with the active audio file lyric content by lyric content;
a touch detection module configured to determine a touch point on the display unit, determine the a lyric content of the lyric content corresponding to the portion of the active audio file being played displayed on the same row of the touch point of the display unit, and determine a time tag corresponding to the determined lyric content according to the recorded time of the timer; and
an adjustment module configured to update the time tag with the determined time tag corresponding to the determined lyric content with the determined time tag when the lyric is not displayed synchronously with the active audio file.

8. The electronic device as described in claim 7, wherein each of the lyrics and the associated audio files has the same filename and different extensions.

9. The electronic device as described in claim 7, wherein the processor further determines whether the lyric associated with the active audio file is stored in the storage unit, if the lyric associated with the played audio file is not stored in the storage unit, the processor is to direct the display unit to display a user interface to prompt to input the lyric or download the lyric through Internet, and further associate the lyric with the active audio file.

10. The electronic device as described in claim 7, wherein the processor updates the time tag with the time tag corresponding to the determined lyric content when the lyric is not displayed synchronously with the active audio file specifically comprises: the processor adds the determined time tag corresponding to the determined lyric content if there is not a time tag corresponding to the determined lyric content, and replaces the existing time tag with the determined time tag corresponding to the determined lyric content if the existing time tag does not match the determined time tag corresponding to the determined lyric content.

11. The electronic device as described in claim 7, wherein the processor further stores the modified lyric to the storage unit.

12. The electronic device as described in claim 7, wherein the processor is further to reset the timer when the played audio file is played back.

13. A method applied to an electronic device, the electronic device comprising a storage unit storing audio files and lyrics associated with the audio files, an audio playback unit being to play the audio files, a display unit to display the lyrics and being a touch-enabled display, and a timer, the method comprising:
controlling the audio playback unit to play a audio file, and directing the timer to time;
controlling the display unit to show lyric content of the lyric associated with the active audio file lyric content being played;
determining a touch point on the display unit, further determining a lyric content corresponding to the portion of the active audio file being played displayed on the same row of the touch point of the display unit and determining a time tag of the determined lyric content according to the recorded time of the timer; and
updating the time tag with the determined time tag corresponding to the determined lyric content with the determined time tag when the lyric content is not displayed synchronously with the played audio file.

14. The method as described in claim 13, wherein the method further comprises:
determining whether the lyric associated with the active audio file is stored in the storage unit;
controlling the display unit to show the lyric associated with the active audio file if the lyric corresponding to the played audio file is stored in the storage unit;
controlling the display unit to display a user interface to prompt to input the lyric or download the lyric, and further associate the lyric with the audio file if the lyric associated with the active audio file is not stored in the storage unit.

15. The method as described in claim 13, wherein the step “updating the time tag with the determined time tag corresponding to the determined lyric content when the lyric content is not displayed synchronously with the active audio file” further comprises:
adding the determined time tag corresponding to the determined lyric content if there is not a time tag corresponding to the determined lyric content;
replacing the existing time tag with the determined time tag corresponding to the determined lyric content if the existing time tag does not match the determined time tag.

16. The method as described in claim 13, wherein the method further comprises:
storing the modified lyric to the storage when the played audio file is played back.

17. The method as described in claim 13, wherein the method further comprises:
resetting the timer when the played audio file is played back.
